(19) United States
(12) Patent Application Publication
(10) Pub. No.: US 2023/0236432 A1
(43) Pub. Date: Jul. 27, 2023

(54) CORRECTING MULTI-ZONE MOTION BLUR

(71) Applicant: Motional AD LLC, Boston, MA (US)

(72) Inventors: Nijumudheen Muhassin, Jefferson Hills, PA (US); Yew Kwang Low, Singapore (SG); Jayesh Dwivedi, Oakmont, PA (US); William Buono, Pittsburgh, PA (US)

(21) Appl. No.: 17/586,651

(22) Filed: Jan. 27, 2022

(51) Int. Cl. G02B 27/30; G06T 5/00; G06T 7/33; B60W 50/00; B60W 60/00

(52) U.S. Cl. CPC G02B 27/30; G06T 5/002; G06T 7/33; B60W 50/0097; B60W 60/0027; B60W 2420/42; B60W 2422/00

(57) ABSTRACT

Provided are methods for correcting multi-zone motion blur, which include executing, using at least one processor, an alignment of at least one image capturing device with at least one collimating device in a plurality of collimating devices, causing a rotation of at least one collimating device, receiving at least one image of at least one target object captured by the image capturing device for processing by at least one rotating collimating device, and determining, based on the at least one processed image, a degradation of the received image of the target object.

### BACKGROUND

An autonomous vehicle is capable of sensing its surrounding environment and navigating without human input. Upon receiving data representing the environment and/or any other parameters, the vehicle performs processing of the data to determine its movement decisions, e.g., stop, move forward/reverse, turn, etc. The decisions are intended to safely navigate the vehicle along a selected path to avoid obstacles and react to a variety of scenarios, such as, presence, movements, etc. of other vehicles, pedestrians, and/or any other objects.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5A is a diagram of an implementation of a system for correcting a multi-zone motion blur;

FIGS. 5B-C are diagrams of an exemplary implementation of a collimator system for correcting a multi-zone motion blur;

FIG. 5D is a diagram of an exemplary camera field of view generated by the system shown in FIG. 5A using the collimator system shown in FIGS. 5B-C; and

FIG. 6 illustrates an example process for correcting a multi-zone motion blur using the system shown in FIG. 5A, according to some embodiments of the current subject matter.

### DETAILED DESCRIPTION

In the following description, numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

A vehicle (e.g., an autonomous vehicle) includes sensors that monitor various parameters associated with the vehicle. For example, some sensors (e.g., cameras, LIDAR sensors, RADAR sensors, SONAR sensors, etc.) monitor/detect changes occurring in the vehicle's environment (e.g., actions and/or presence of other vehicles, pedestrians, street lights, etc.). The information/data received from the sensors is used by the vehicle's controller (or any other processing component) to determine path of travel, direction, speed, and/other movement parameters.

Rolling shutter sensors may be preferred in autonomous vehicle cameras because of their high dynamic range when compared to global shutter cameras. However, use of such cameras is associated with motion-blurring of images captured by such cameras. Analysis of such motion blur is important in determining camera performance and/or future maneuvers of the vehicle. A modulation transfer function (MTF) is used to assess degradation (motion blur) of an image of a target object. Conventional systems are limited in analysis of motion blur in that they are extremely large, require a specific distance between the camera capturing the target object and the target object, and allow checking of motion blur MTF across a horizontal field of view only.

In some embodiments, the current subject matter system is configured to resolve the above problems by providing two collimators that are aligned in accordance with one or more fields of view zone associated with a camera capturing an image. The collimators are then rotated at a particular speed. The speed is determined based on a specific collimator rotation radius (which may be specific to a particular field of view), distance to/speed of the target object. Each pair of collimators may be rotated at their own speed. An MTF is then computed based on the collimated image to determine degradation of the image. A determination may then be made by the vehicle's controller whether or not accept the degradation of the image of the target object and use it in determining future maneuvers of the vehicle.

In some embodiments, one or more processors (e.g., ego vehicle's arbitration unit, controller, etc.) execute an alignment of at least one image capturing device (e.g., vehicle's camera and/or any associated camera sensors) with at least one collimating device in a plurality of collimating devices (e.g., stationary collimator(s), rotating collimators). Execution of the alignment of the image capturing device allows positioning and alignment of the device with respect to one or more collimators for the purposes of computing of a modulation transfer function and, subsequently, quantifying whether a particular blurring of an object viewed by the image capturing device is or is not acceptable.

The processors then trigger or cause a rotation of at least one collimating device. At least one image of at least one target object (e.g., another vehicle on a road, a pedestrian, etc.) captured by the image capturing device is received for processing by the rotating collimating device. The processors then determine a degradation of the received image of the target object based on the processing of the image by the collimators. This allows for blur testing of the received image of the target object. The vehicle's controller can then determine whether or not to accept the received image based on the determined degradation.

In some embodiments, the collimating device(s) are configured to be rotated at a predetermined rotation speed.

In some embodiments, rotation of the collimating device(s) includes a rotation of a pair of collimating devices. The current subject matter system can include any number of collimating devices. The collimating devices can be positioned and/or rotated in pairs for the purposes of processing image blur. In some embodiments, the collimating devices can include at least one stationary collimating device that is configured to be stationary.

In some embodiments, the predetermined rotation speed is determined based on at least one of the following parameters: a distance to the target object, a speed of travel of the target object, a rotation radius of the at least one collimating device, a number of image pixels of the captured image of the object being observed by the at least one collimating device during a predetermined period of time, and any combination thereof.

In some embodiments, each collimating device is configured to be aligned with at least one field of view in a plurality of field of views of the image capturing device. For example, a pair of collimators can be aligned with a particular field of view, while another pair of collimators can be aligned with another field of view.

In some embodiments, at least one collimating device and the image capturing device are positioned in a vehicle.

In some embodiments, the process for determining motion blur also includes a determination of one or more settings and/or configurations of an optical system, e.g., an optical system (e.g., cameras, sensors, etc.) of an autonomous vehicle. Such settings/configurations can be used by the optical system to prevent occurrence of degradation of an image (e.g., a motion blur) subsequently detected and/or obtained by the optical system. For example, the current subject matter system can be used to during a simulation of a movement of an autonomous vehicle to determine whether degradation of images of target objects (e.g., other vehicles, pedestrians, etc.) detected by the optical system (e.g., cameras, sensors, etc.) of the vehicle occurs. If so, the settings/configurations (e.g., positioning, number, etc. of optical components, shutter speed, exposure, etc.) of the optical system can be appropriately adjusted to prevent/avoid image degradation. The simulations and/or adjustments of settings/configurations can occur in real-time and/or during an optical system design-time. Moreover, by way of a non-limiting example, such optical system adjustment can also cause adjustments in generation of at least one future motion maneuver of the vehicle. The future motion maneuver(s) can be characterized by at least one of the following parameters of the vehicle: a speed, a position, an acceleration, a direction of movement, and any combination thereof. This allows use of degradation (e.g., blur) of the target object to determine any future movements of the vehicle.

In some embodiments, the degradation of the received image of the target object includes a blurring of at least a portion of the image of the target object. Further, as part of the determining of the degradation, the processor(s) compute a modulation transfer function of the portion of the image of the target object. Hence, the MTF can be used by the processor(s) to assess blurring.

In some embodiments, the processor(s) generate at least one future motion maneuver of the vehicle based on the computed modulation transfer function. For example, using the computed modulation transfer function (e.g., by accepting or rejecting the results of the computed MTF), the vehicle's controller can adjust vehicle's movements.

By virtue of the implementation of systems, methods, and computer program products described herein, techniques for correcting a multi-zone motion blur allow a quick determination of an acceptable motion blur (e.g., for processing by the vehicle's controller) and are independent of specific characteristics of a target object (e.g., a preset distance).

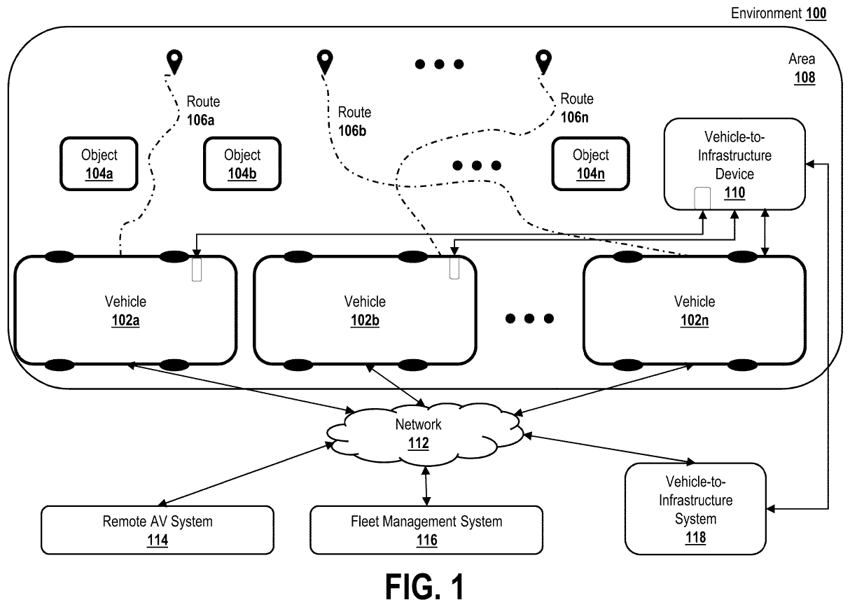

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

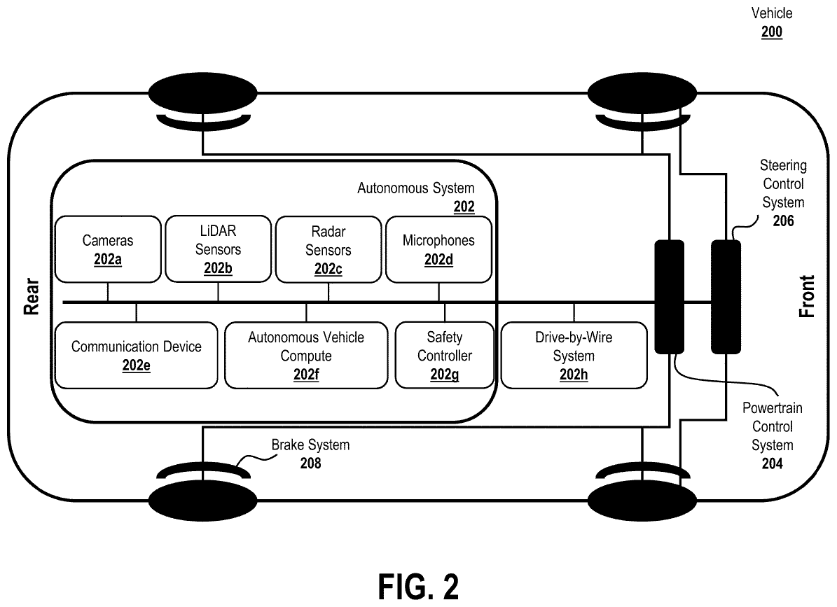

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

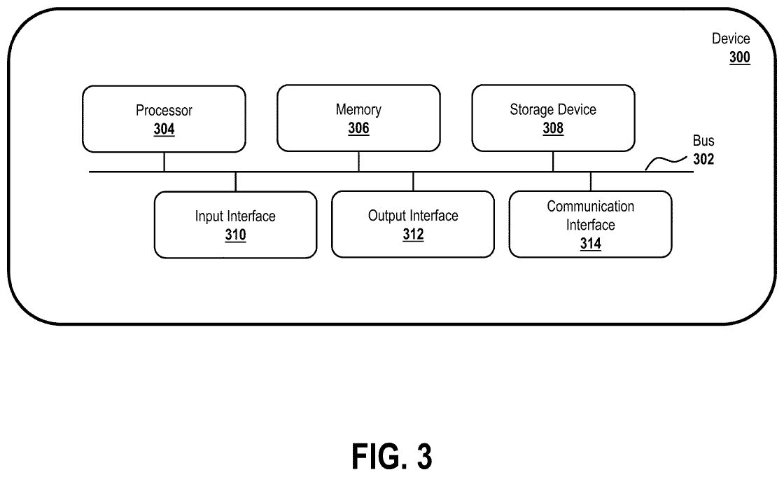

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of other devices/objects shown in FIG. 1, and/or one or more devices of network 112 (e.g., one or more devices of a system of network 112). In some embodiments, one or more devices of vehicles 102 (e.g., one or more devices of a system of vehicles 102), at least one device of other devices/objects shown in FIG. 1, and/or one or more devices of network 112 (e.g., one or more devices of a system of network 112) include at least one device 300 and/or at least one component of device 300.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

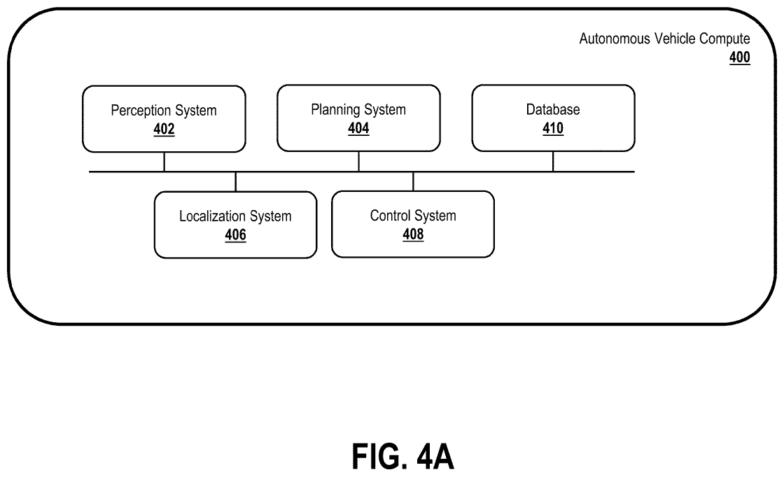

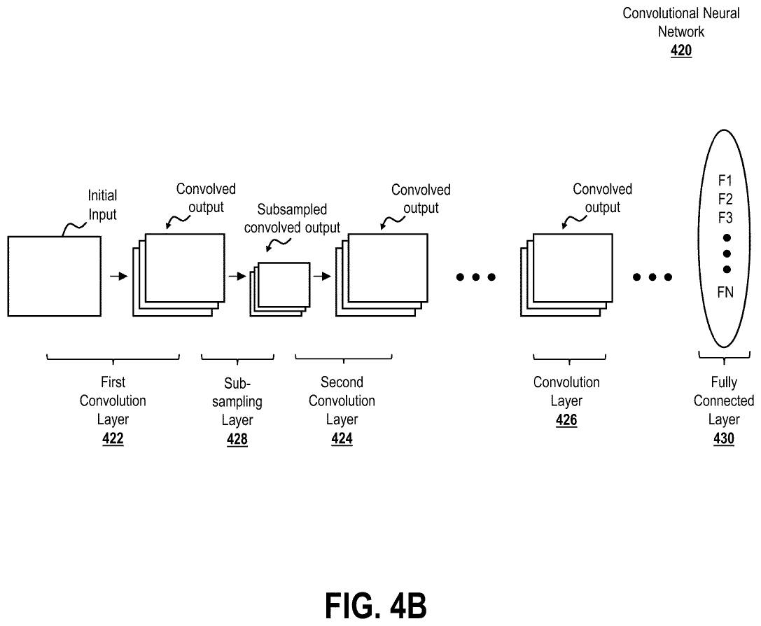

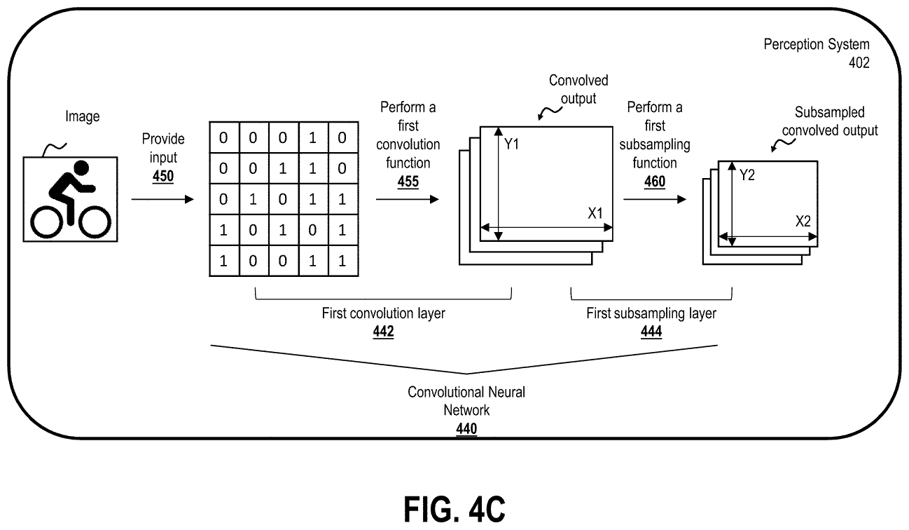

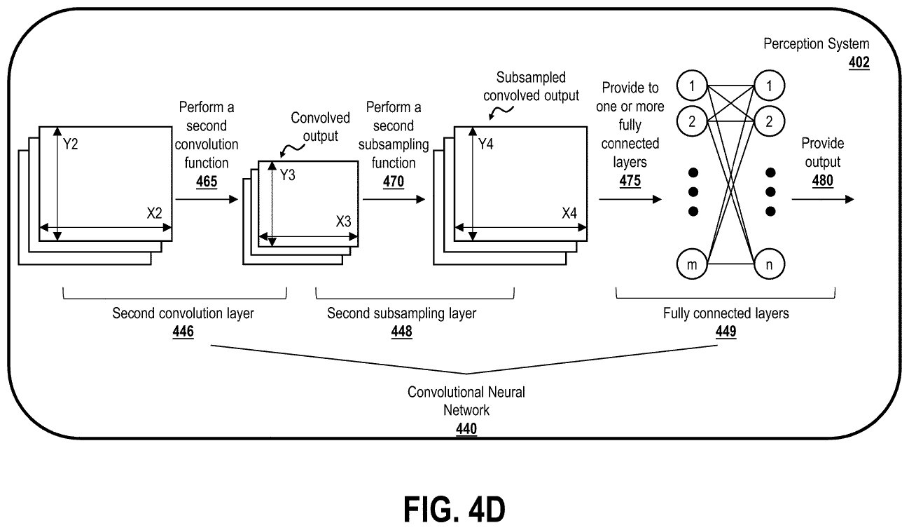

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 420 normalizing sensor data (e.g., image data, LiDAR data, radar data, and/or the like).

In some embodiments, CNN 420 generates an output based on perception system 420 performing convolution operations associated with each convolution layer. In some examples, CNN 420 generates an output based on perception system 420 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 420 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

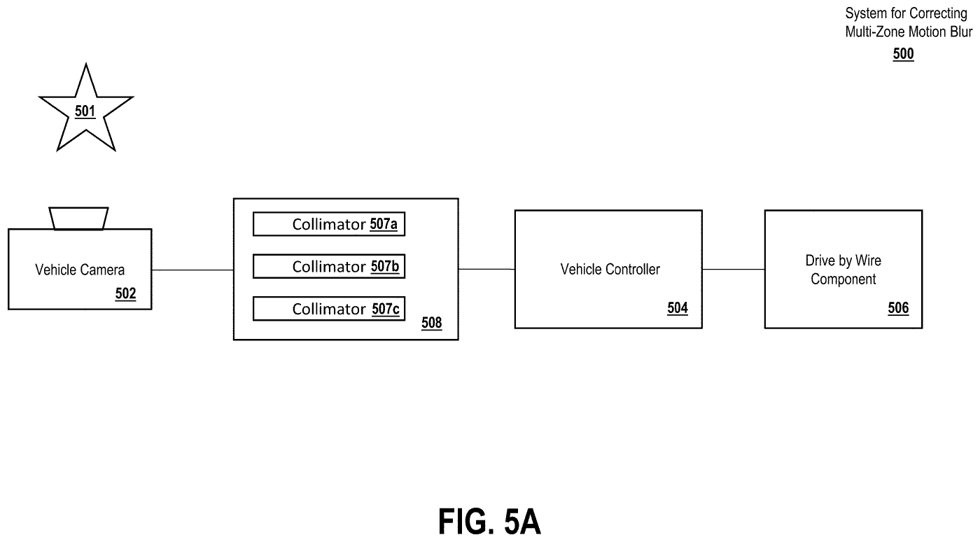

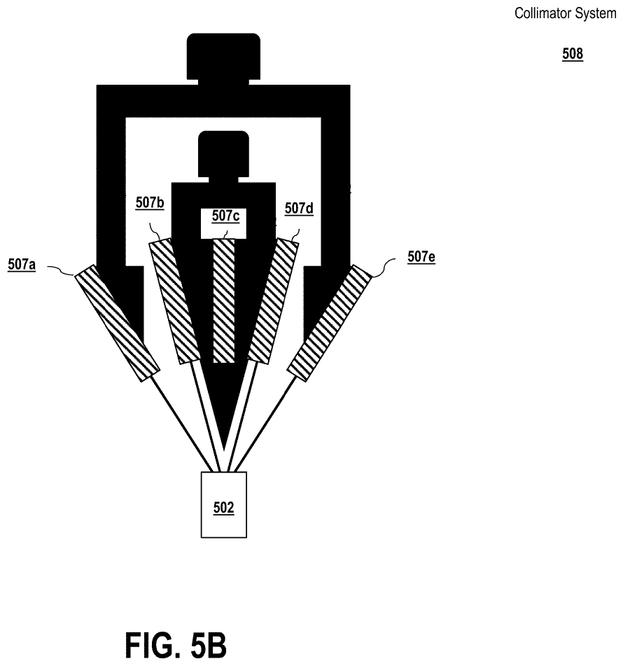

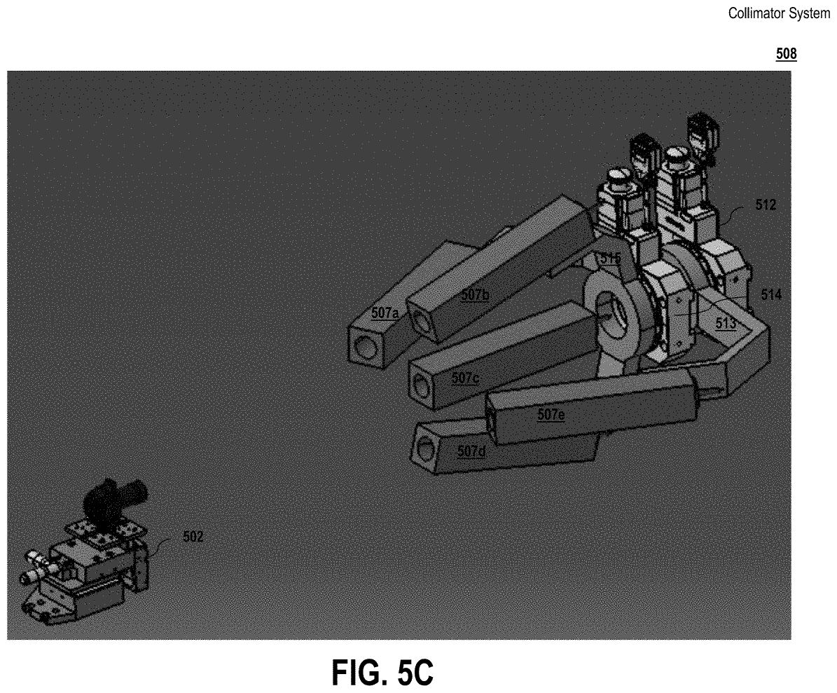

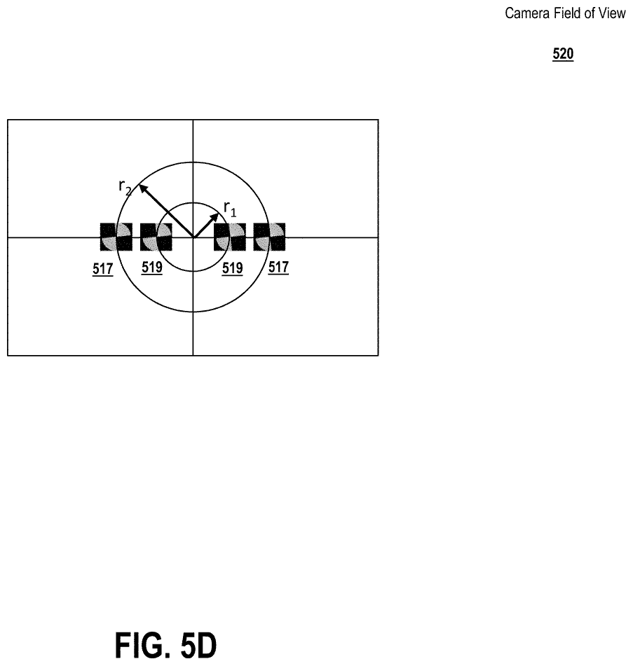

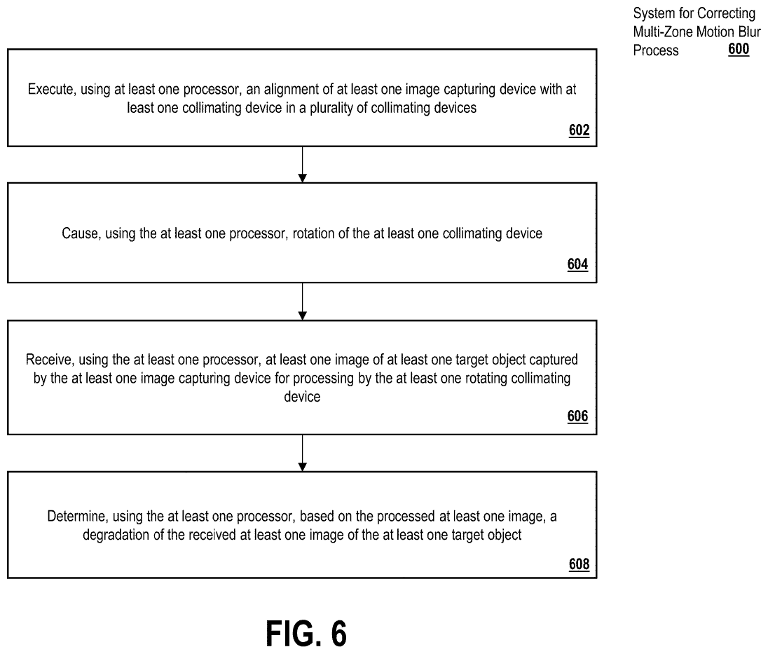

Referring now to FIG. 5A, illustrated is a diagram of an implementation of a system for correcting a multi-zone motion blur. FIGS. 5B-C illustrate an exemplary implementation of a collimator system for correcting a multi-zone motion blur. FIG. 5D illustrates an exemplary camera field of view generated by the system shown in FIG. 5A using the collimator system shown in FIGS. 5B-C. FIG. 6 is a flow chart illustrating an example of a process for correcting a multi-zone motion blur.

As stated above, a vehicle (e.g., an autonomous vehicle) includes sensors that monitor various parameters associated with the vehicle. For example, some sensors monitor/detect changes occurring in the vehicle's environment, while others monitor/detect various aspects associated with operational aspects of the vehicle. Any information/data transmitted by the sensors to the vehicle's controller (or any other processing component) is used by the controller's component to determine path of travel, direction, speed, and/other movement and/or maneuver parameters. Periodically, images of target objects obtained by vehicle's cameras appear blurry (which may be referred to as “motion blur”). This may be due to motion of the vehicle, the target object and/or any other factors. Such motion blur may prevent identification of target objects during object classifications in a processing pipeline (e.g., Al pipeline) executed by the vehicle's controller. The current subject matter is configured to resolve motion blur through use of a multi-zone motion blur modulation transfer function (MTF) testing.

FIG. 5A illustrates an example of a system 500 for correcting multi-zone motion blur, according to some embodiments of the current subject matter. The system 500 can be incorporated into a vehicle (e.g., vehicle 102 shown in FIG. 1, vehicle 200 shown in FIG. 2, etc.) and/or be a separate testing system that may be used to determine motion blur parameters at design time so that an optical system employing such determined motion blur parameters can be implemented at runtime (e.g., in an autonomous vehicle). The system 500 includes one or more sensors (e.g., a vehicle camera 502), a vehicle controller 504, and drive-by-wire (DBW) component 506. The system 500 can also incorporate other components associated with operation of an autonomous vehicle (as described above). Moreover, the system 500 can include a collimator system 508 that can include one or more collimators 507 (a, b, c) as well as associated mounting hardware, frame(s) for securing the collimators, motors for rotating the collimators, etc. (not shown in FIG. 5A). Any type of existing cameras and/or collimators can be used. The vehicle's controller 504 can control operation of the vehicle's sensors (e.g., camera 502) and the collimator system 508. The drive by wire component 506 can execute vehicle maneuvers that are determined by the vehicle's controller 504.

The vehicle's camera(s) 502 captures an image of a target object 501. The vehicle's sensors 502 also monitor various parameters associated with the vehicles. The parameters include, but are not limited to, parameters associated with vehicle's state, e.g., heading, driving speed, etc. Additionally, the parameters include, but are not limited to, parameters associated with vehicle's health, e.g., tire inflation pressure, oil level, transmission fluid temperature, etc. The vehicle's sensors (e.g., camera, LIDAR, SONAR, etc.) further monitor various parameters associated an environment surrounding the vehicle. These parameters include, but are not limited to, parameters associated with other vehicles (e.g., speed, direction, etc.) and/or other objects (e.g., pedestrian stepping out on a roadway in front of the vehicle). The camera 502 and/or any other sensors supply data for one or more measured/monitored parameters to the vehicle controller 504.

To perform correction of a multi-zone motion blur associated with an image of a target object 501 captured by the camera 502, the vehicle controller 502 and/or any other processor executes an alignment process of the vehicle's camera 502 to position and align the camera 502 with respect to at least one collimating device 507, e.g., a stationary collimator 507b and rotating collimators 507a and 507c. The alignment can involve physical movement of the camera and/or the collimators 507 as well as changing various operational parameters (e.g., focus, shutter speed, collimator rotation speed, etc.) associated with the camera and/or the collimators. As can be understood, there can be any number of collimators 507 that can be aligned with the camera 502.

Once the camera 502 is aligned with the collimators 507, the collimators 507 start rotating. The camera 502 also obtains an image of the target object 501. Obtaining of the image 501 can be performed simultaneously with the start of rotation of the collimators 507. Alternatively, or in addition to, rotation of collimators and obtaining of the image of the target object 501 can be performed in any order. The obtained image can be presented to the rotating collimators 507 for processing. Using the rotating collimators 507, the system 500 can perform blur testing (e.g., determining whether a blur associated with an image is acceptable or not) of an image of the target object 501. The blur testing can determine a level of degradation of the received image. The level of degradation is determined using a modulation transfer function (MTF). For example, the determined level of degradation (e.g., a numerical value associated with the level) can be compared by the controller 504 to a predetermined threshold value. If the determined level of degradation of the image is greater than the threshold value, the controller 504 can reject the image and not use it for any further processing, such as, for instance, determining future maneuvers of the vehicle. In some example embodiments, acceptability of a particular level of degradation (e.g., image blur) of an obtained image may be dependent on a particular use case and/or whether any of the computing systems and/or components configured to subsequently process the image will be able to process it, e.g., detect and/or identify objects contained in the image to a certain degree of certainty/confidence that may be required and/or expected from the specific computing system/component.

Referring to FIGS. 5B-C (where FIG. 5C is a 3-dimensional rendering corresponding to FIG. 5B), an exemplary collimator system 508 includes collimators 507 (a, b, c, d, e) (collimators 507d and 507e are not shown in FIG. 5A) mounted on separate rotating frames. Each frame has mounting arms for securing respective collimators 507. For example, collimators 507a and 507e are mounted on a rotating frame 513 having arms 513a and 513b, where collimator 507a is mounted on the arm 513a and collimator 507e is mounted on the arm 513b. Similarly, collimators 507b and 507d are mounted on a rotating frame 515 having arms 515a and 515b, where collimator 507b is mounted on the arm 515a and collimator 507d is mounted on the arm 515b. Collimator 507c can be stationary and can be mounted on its own arm (not shown in FIG. 5B).

To allow rotation of the frames 513 and 515, each frame is configured to be coupled to a respective motor. For example, frame 513 is coupled to the motor 512 and frame 515 is coupled to the motor 514. Any desired ways of coupling frames to the motors can be used. Operation of the motors 512 and 514 is controlled by the controller 504 and/or any other processor. Upon receiving a command to rotate, the motors 512, 514 rotate the respective frames 513 and 515. Rotation of the frames 513, 515 by the respective motors 512, 514 can be performed using the same and/or different speeds, directions, intervals and/or controlled using any other desired parameters. The frames can be rotated independently of one another and/or in a predetermined sequence. Moreover, one or more parameters associated with the camera 502, such as, for instance, its distance away from the collimators, camera-collimator alignments, etc. can also affect rotational characteristics of the collimators 507. In some example embodiments, the collimators and the camera can be setup to ensure that an optical center of one or more collimators is aligned with the optical center of the camera. If alignment is incorrect or off, the subsequent determinations using MTF will be affected and/or be incorrect. In further example embodiments, the distance(s) between the camera 502 and collimators 507 can be minimized to ensure that camera's field(s) of view encompass collimator(s)' MTF target values.

The mounting of the collimators 507 to the respective arms 513, 515 allows for adjustment of positions of collimators 507 in any desired direction. The adjustment can be performed manually, automatically, and/or in any desired fashion. In some embodiments, the controller 504 (and/or any other processor) can perform automatic adjustment of position and/or direction of the collimators 507. Each collimator 507 can be adjusted separately from another collimator 507. Alternatively, or in addition, each pair of collimators (e.g., 507a and 507e, 507b and 507d) can be adjusted at the same time.

In some embodiments, collimator arms 513 (a, b) and 515 (a, b) are positioned at a predetermined distance or radius away from a center of rotation (e.g., as defined by a respective motor and/or frame). For instance, collimator arms 515 (a, b) are positioned using radius r₁ (e.g., r₁=0.5 Field (F) or 50% of the field of view of the camera 502 (where 1F corresponds to the full field of view of the camera)) and collimator arms 513 (a, b) are positioned using radius r₂ (e.g., r₂=0.85 F or 85% of the field of view of the camera 502).

The positions of the collimator arms (and/or radii (e.g., r₁, r₂) at which the collimator arms and/or collimators are positioned) and/or alignment of the respective collimators 507 allow focusing the collimators 507 on specific field of view (FOV) zones associated with the camera 502. FIG. 5D illustrates exemplary fields of view 520 as observed by the camera 502, according to some implementations of the current subject matter. Collimators 507 are focused on a specific field of view zone. For example, as shown in FIG. 5D, collimators 507a and 507e, rotating at radius r₂, are focused on a field of view zone 517 that is observed by the camera 502. Collimators 507b and 507d rotating at radius r₁, are focused on a field of view zone 519 that is observed by camera 502. As shown in FIGS. 5B-5D, two collimators are focused on one field of view zone of the camera; however, as can be understood any number of collimators can be focused on any one field of view zone. The MTF values obtained from all collimators 507 (including rotating and stationary) are compared to determine whether there is degradation of the obtained image of the target object.

Once focused on a field of view zone, the collimators are rotated by the respective motors 512, 514, to simulate a motion with respective revolutions per minute (rpm) to match various speed requirements. This allows simulation of real driving conditions to determine whether a setup of an optical system (e.g., cameras, sensors, etc.) of the autonomous vehicle causes occurrences of image degradation (e.g., blur). The collimators 507 can be rotated at different rotating speeds, that may correspond to different driving speeds of the vehicle, to determine occurrence of image degradation that may occur during actual driving conditions. If degradation occurs, one or more settings/configurations (e.g., positioning, number, etc. of optical components, shutter speed, exposure, etc.) of the optical system can be appropriately adjusted to prevent/avoid image degradation (e.g., when the optical system is implemented in the vehicle). The simulations and/or adjustments of settings/configurations can occur in real-time and/or during an optical system design-time. Rotation speed of the collimators can be characterized by pixels (of the image of the target object 501 as obtained by the camera 502) per unit of time (e.g., seconds). The rotation speed of pixels per second can be translated into meters per second using a distance from the camera 502 to the target object 501. As such, collimator movement (Pₓ), which is determined using a radius (r) of rotation of a collimator and an angle (θ) of rotation of the collimator with respect to the center of the system, and can be expressed as follows:

r₁*θ₁=r₂*θ₂=Pₓ (1)

Thus, rotational speed (RPM) of each pair of collimators (RPM₁ for the collimators 507b and 507d, RPM₂ for collimators 507a and 507e) can be determined using the following system of equations:

RPM₁=(Pₓ*60)/(2π*r₁)

RPM₂=(Pₓ*60)/(2π*r₂) (2)

FIG. 6 is a flow chart illustrating a process 600 for correcting a multi-zone motion blur using the system 500, and in particular the collimator system 508, according to some implementations of the current subject matter. At 602, the controller 504 executes an alignment of the camera 502 to align it with collimators 507. The collimators 507 are adjusted in pairs so that each pair of collimators is focused on a particular field of view zone (e.g., collimators 507a and 507e are focused on the field of view zone 517 and collimators 507b and 507d are focused on the field of view zone 519, as shown in FIG. 5D). As described above, each pair of collimators 507 is configured to rotate about a center axis defined by the frame holding the collimators (e.g., frame 513, 515) and/or the respective motors (e.g., motors 512, 514). Each pair of collimators rotates using a predetermined radius (e.g., r₁, r₂) away from the center axis.

Once alignment of the camera 502 and the collimators 507 is complete, the motors 512, 514 begin operating and cause rotation of the collimators 507, at 604. For example, the motors 512, 514 can receive an appropriate instruction from the vehicle's controller 504 and/or any other processor to rotate each pair of collimators 507 at a particular speed (e.g., one pair of collimators rotating faster than the other; both pairs rotating at the same speed, etc.; one pair of collimators is station while the other is rotating, etc.), direction (e.g., clockwise, counterclockwise), etc. Rotation instructions from the vehicle's controller 504 and/or any other processor can be received in real-time, thereby causing adjustment of collimator positions, rotational characteristics (e.g., speed, direction, etc.), etc. in real-time.

In some embodiments, rotation speed of each pair of collimators can be determined using the above equations (1) and (2). The speed can also be based on at least one of the following: a distance to the target object 501, a speed of travel of the target object 501, a rotation radius (e.g., r₁, r₂) of the at least one collimating device, a number of image pixels of the captured image of the object 501 being observed by the at least one collimating device during a predetermined period of time, and any combination thereof.

At 606, the collimators 507 begin processing an image of the target object 501 that was obtained by the camera 502. The vehicle's controller 504 and/or any other processor uses the processed image to determine its degradation (e.g., blurring), at 608. The controller/processor determines degradation of the image for each field of view zone 517, 519. To determine image degradation, it uses a modulation transfer function (MTF).

MTF is a variant of an optical transfer function (OTF) associated with an optical system, e.g., a camera, microscope, human eye, projector, etc. The OTF specifies how different spatial frequencies are to be handled by the optical system and is used to define how the system's optics project light from the object or scene (e.g., camera 502) onto a photographic film, detector array, retina, screen, etc. The MTF also neglects phase effects of the OTF. The OTF further specifies a response to a periodic sine-wave pattern passing through the optical system, as a function of its spatial frequency or period, and its orientation. The OTF is defined as the Fourier transform of the point spread function (PSF), i.e., an impulse response of the optics, the image of a point source. The MTF is defined as the absolute value of the complex OTF and defines relative contrast (or contrast reduction). The MTF values indicate how much of the object's contrast is captured in the image as a function of spatial frequency.

In some embodiments, the vehicle's controller 504 and/or any other processor computes the MTF with regard to at least a portion of the image of the target object 501 as obtained by the camera 502. The MTF is defined as a ratio of image contrast to the target contrast expressed as a function of spatial frequency. For example, the spatial frequency line pair/mm represents the limit of how many line pairs an optical (e.g., a camera) system can resolve within a millimeter, where MTF defines a contrast level at such spatial frequency expressed as a percentage. The results of the computation of the MTF are then analyzed by the controller 504 and/or any other processor to determine whether or not the computed MTF represents an image blur that may or may not be acceptable by the system 500 for further processing. For example, the vehicle's controller 504 can use the results of the computation of the MTF to determine one or more future motion maneuvers of the vehicle. Such future motion maneuvers can be characterized by at least one of the following: a speed, a position, an acceleration, a direction of movement, and any combination thereof of the vehicle. As stated above, whether or not a particular level of degradation (e.g., image blur) in the obtained image is acceptable may depend on a specific use case of the current subject matter system and/or whether any of the computing systems and/or components configured to subsequently process the image will be able to process the obtained image, e.g., detect and/or identify objects contained in the image to a certain degree of certainty/confidence that may be required and/or expected from the specific computing system/component. Such degree of certainty/confidence may be specific to a particular implementation.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
executing, using at least one processor, an alignment of at least one image capturing device with at least one collimating device in a plurality of collimating devices;
causing, using the at least one processor, rotation of the at least one collimating device;
receiving, using the at least one processor, at least one image of at least one target object captured by the at least one image capturing device for processing by the at least one rotating collimating device; and
determining, using the at least one processor, based on the processed at least one image, a degradation of the received at least one image of the at least one target object.

2. The method of claim 1, wherein the at least one collimating device is configured to be rotated at a predetermined rotation speed.

3. The method claim 1, wherein the rotation of the at least one collimating device includes a rotation of a pair of collimating devices.

4. The method of claim 2, wherein the predetermined rotation speed is determined based on at least one of the following: a distance to the target object, a speed of travel of the target object, a rotation radius of the at least one collimating device, a number of image pixels of the captured image of the object being observed by the at least one collimating device during a predetermined period of time, and any combination thereof.

5. The method of claim 1, wherein the plurality of collimating devices further includes at least one stationary collimating device configured to be stationary.

6. The method of claim 1, wherein each collimating device in the plurality of collimating devices is configured to be aligned with at least one field of view in the plurality of field of views of the at least one image capturing device.

7. The method of claim 1, wherein at least one of the at least one collimating device and the at least one image capturing device are positioned in a vehicle.

8. The method of claim 7, further comprising generating, using the at least one processor, at least one future motion maneuver of a vehicle based on the determining the degradation of the received at least one image of the at least one target object, the at least one future motion maneuver being characterized by at least one of the following: a speed, a position, an acceleration, a direction of movement, and any combination thereof of the vehicle.

9. The method of claim 8, wherein the degradation of the received at least one image of the at least one target object includes a blurring at least a portion of the at least one image of the at least one target object.

10. The method of claim 9, wherein the determining further comprises computing, using the at least one processor, a modulation transfer function of the at least a portion of the at least one image of the at least one target object.

11. The method of claim 10, wherein the generating further comprises generating, using the at least one processor, the at least one future motion maneuver of the vehicle based on the computed modulation transfer function.

12. A system, comprising:
at least one processor, and
at least one non-transitory storage media storing instructions that, when executed by the at least one processor, cause the at least one processor to perform operations comprising:
executing an alignment of at least one image capturing device with at least one collimating device in a plurality of collimating devices;
causing rotation of the at least one collimating device;
receiving at least one image of at least one target object captured by the at least one image capturing device for processing by the at least one rotating collimating device; and
determining based on the processed at least one image, a degradation of the received at least one image of the at least one target object.

13. The system of claim 12, wherein the at least one collimating device is configured to be rotated at a predetermined rotation speed.

14. The method of claim 12, wherein the rotation of the at least one collimating device includes a rotation of a pair of collimating devices.

15. The method of claim 13, wherein the predetermined rotation speed is determined based on at least one of the following: a distance to the target object, a speed of travel of the target object, a rotation radius of the at least one collimating device, a number of image pixels of the captured image of the object being observed by the at least one collimating device during a predetermined period of time, and any combination thereof.

16. The method of claim 12, wherein the plurality of collimating devices further includes at least one stationary collimating device configured to be stationary.

17. The method of claim 12, wherein each collimating device in the plurality of collimating devices is configured to be aligned with at least one field of view in the plurality of field of views of the at least one image capturing device.

18. The method of claim 12, wherein at least one of the at least one collimating device and the at least one image capturing device are positioned in a vehicle.

19. The system of claim 18, further comprising generating, using the at least one processor, at least one future motion maneuver of the vehicle based on the determining the degradation of the received at least one image of the at least one target object, the at least one future motion maneuver being characterized by at least one of the following: a speed, a position, an acceleration, a direction of movement, and any combination thereof of the vehicle;
wherein the degradation of the received at least one image of the at least one target object includes a blurring at least a portion of the at least one image of the at least one target object;
wherein the determining further comprises computing, using the at least one processor, a modulation transfer function of the at least a portion of the at least one image of the at least one target object;
wherein the generating further comprises generating, using the at least one processor, the at least one future motion maneuver of the vehicle based on the computed modulation transfer function.

20. At least one non-transitory storage media storing instructions that, when executed by at least one processor, cause the at least one processor to perform operations comprising:
executing an alignment of at least one image capturing device with at least one collimating device in a plurality of collimating devices;
causing rotation of the at least one collimating device;
receiving at least one image of at least one target object captured by the at least one image capturing device for processing by the at least one rotating collimating device; and
determining based on the processed at least one image, a degradation of the received at least one image of the at least one target object.
